(19) United States
(12) Patent Application Publication
(10) Pub. No.: US 2007/0164537 A1
(43) Pub. Date: Jul. 19, 2007

(54) ATV trailer

(76) Inventor: Steve Earl Lee, Grants Pass, OR (US)

Correspondence Address: R. Keith Harrison, 2139 East Bert Kouns, Shreveport, LA, 71105, US

(21) Appl. No.: 11/318,302

(22) Filed: Dec. 23, 2005

(51) Int. Cl. B60R 7/00

(52) U.S. Cl. 280/415.1; 296/37.1

(57) ABSTRACT

An ATV trailer is disclosed. An illustrative embodiment of the ATV trailer includes a portable trailer frame, at least one seat provided on the trailer frame and a basket provided on the trailer frame beneath the at least one seat.

### FIELD

The present invention relates to all-terrain vehicles (ATVs). More particularly, the present invention relates to an ATV trailer which can be towed behind an all-terrain vehicle to carry persons and/or supplies, for example.

### BACKGROUND

In recent years, the popularity of all-terrain vehicles (ATVs) has exploded. A typical ATV includes a frame which is mounted on four or six wheels driven by an internal combustion engine. A seat and handlebars are provided on the frame to accommodate a driver and typically at least one passenger who can sit on the seat behind the driver. The ATV may be fitted with various accessories such as a front rack, a rear rack or both front and rear racks to carry supplies such as during a hunting, fishing or camping expedition, or skies for snow mobiles, for example. A typical conventional ATV is suitable for transporting one or two persons as they sit on the seat of the ATV. However, in the event that an injured person must be retrieved from a remote area such as a hunting or camping site, for example, an ATV is typically unsuitable for carrying such a person to a site for medical treatment.

### SUMMARY

The present invention is generally directed to an ATV trailer which can be towed behind an all-terrain vehicle. An illustrative embodiment of the ATV trailer includes a portable trailer frame, at least one seat provided on the trailer frame and a basket provided on the trailer frame beneath the at least one seat.

### BRIEF DESCRIPTION OF THE DRAWINGS

The invention will now be described, by way of example, with reference to the accompanying drawings, in which:

FIG. 1 is a side perspective view of an illustrative embodiment of an ATV trailer according to the present invention, coupled to an ATV;

FIG. 2 is a rear view of an illustrative embodiment of an ATV trailer according to the present invention;

FIG. 3 is a side view of an illustrative embodiment of an ATV trailer according to the present invention, with a stretcher (shown in phantom) supported on the ATV trailer;

FIG. 4 is a top perspective view of a stretcher which can be used in implementation of an ATV trailer according to the present invention;

FIG. 5 is a top view of the stretcher shown in FIG. 4;

FIG. 6 is a side view of the stretcher shown in FIG. 4;

FIG. 7 is a top view of an illustrative embodiment of an ATV trailer according to the present invention, with a stretcher provided on the ATV trailer; and

FIG. 8 is a top view of a collapsible stretcher shown in a collapsed or retracted position.

### DETAILED DESCRIPTION

Referring to the drawings, an illustrative embodiment of an ATV trailer according to the present invention is generally indicated by reference numeral 1. The ATV trailer 1 is adapted to be coupled to an all-terrain vehicle (ATV) 60, which may be conventional. The ATV 60 typically includes an ATV frame 61 having four, six or eight wheels 62, for example. A chassis 63 and seat 67 are provided on the ATV frame 61. Handlebars 64 are attached to the front wheels 62 for steering of the ATV 60. A hitch bar 65, typically fitted with a hitch ball 66, extends rearwardly from the ATV frame 61, between the rear wheels 62.

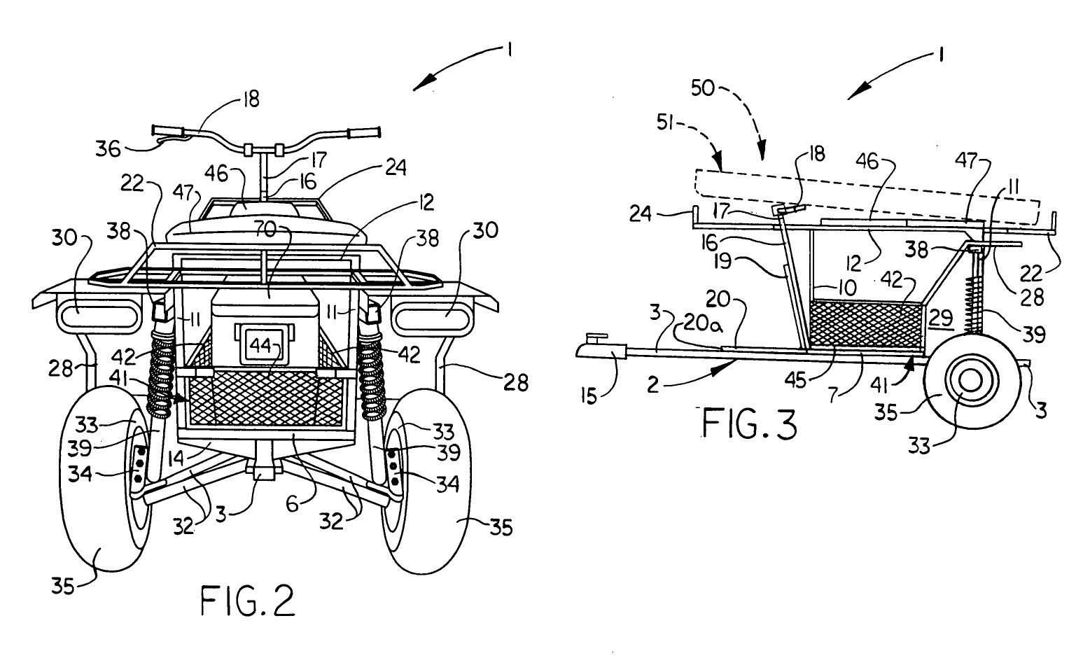

The ATV trailer 1 includes a trailer frame 2 having an elongated trailer tongue 3. A hitch coupling, such as a ball coupling 15, for example, is provided on the forward end of the trailer tongue 2. A front frame member 4 and a middle frame member 5 are typically welded or otherwise attached to the trailer tongue 3, in spaced-apart relationship with respect to each other. As shown in FIG. 2, a rear frame member 6 is further provided on the trailer tongue 3, in spaced-apart relationship to the middle frame member 5. A gusset 14 may be provided between the trailer tongue 3 and rear frame member 6 for reinforcement purposes. The front frame member 4, middle frame member 5 and rear frame member 6 are disposed in generally perpendicular relationship to the trailer tongue 3. A pair of side frame members 7 spans the respective ends of the front frame member 4 and the middle frame member 5. At least one frame stabilizer 8 may span the side frame members 7, between the front frame member 4 and the middle frame member 5. A pair of front frame braces 20 may extend or angle from the respective side frame members 7 and converge toward each other, joining at an apex 20a.

A pair of front vertical frame members 10 extends upwardly from the front frame member 4, in generally parallel, spaced-apart relationship to each other. As shown in FIG. 2, a pair of rear vertical frame members 11 extends upwardly from the rear frame member 6, in generally parallel, spaced-apart relationship to each other. A seat frame 12 is supported by the front vertical frame members 10 and the rear vertical frame members 11. At least one seat is provided on the seat frame 12. For example, a front seat 46 and a rear seat 47, each of which may be padded, may be provided on the seat frame 12. At least one rack may be provided on the trailer frame 2. For example, a rear rack 22 and/or a front rack 24 may be provided on the rear end and/or the front end, respectively, of the seat frame 12.

Handlebars 18 may be provided on the trailer frame 2. A handlebar support member 16 may extend upwardly from the front frame member 4, between the side frame members 7. A handlebar support arm 17 may be adjustably and telescopically extendable from the handlebar support member 16. The handlebars 18 are provided on the handlebar support arm 17. Accordingly, the handlebars 18 may be vertically adjustable by extending or retracting the handlebar support arm 17 in the handlebar support member 16. A dirt shield 19 may be provided on the handlebar support member 16.

A pair of wheels 33 is provided on the trailer frame 2. Accordingly, as shown in FIG. 2, a pair of axles 32 extends outwardly and downwardly from each side of the trailer tongue 3. A wheel 33 is rotatably mounted on each pair of axles 32. A brake assembly 34 may be provided on each wheel 33. A brake handle 36 provided on the handlebars 18 or elsewhere on the trailer frame 2 is connected to the brake assemblies 34 to apply braking pressure to the wheels 33. A pneumatic tire 35 is provided on each wheel 33. A shock absorber frame member 38 is welded or otherwise attached to each side of the trailer frame 2, above each axle pair 32. A shock absorber 39 extends between each axle pair 32 and shock absorber frame member 38 on each side of the trailer frame 2. Accordingly, each shock absorber 39 is adapted to absorb shock during towing of the ATV trailer 1 by the ATV 60, which will be hereinafter described.

A pair of wheel fenders 28 may be provided on the trailer frame 2 above the respective wheels 33. Each wheel fender 28 may be welded or otherwise attached to the middle frame member 5, the shock absorber frame member 38 and rear vertical frame member 11, for example, on the corresponding side of the trailer frame 2. An inside fender plate 29 may be welded or otherwise attached to the trailer frame 2, inside each wheel fender 28. At least one light 30 may be provided on the trailer frame 2. For example, lights 30 may be provided on the respective wheel fenders 28 or elsewhere on the rear portion of the trailer frame 2. The lights 30 are connected electrically to lights on the ATV (not shown) or alternatively to a battery (not shown) on the trailer frame 2 and connected to the lights 30. The lights 30 may be connected to the brake handle 36 for illumination of the lights 30 upon application of the brake handle 36. Alternatively, the lights 30 may be independently illuminated using a switch (not illustrated) provided on the handlebars 18 or elsewhere on the trailer frame 2.

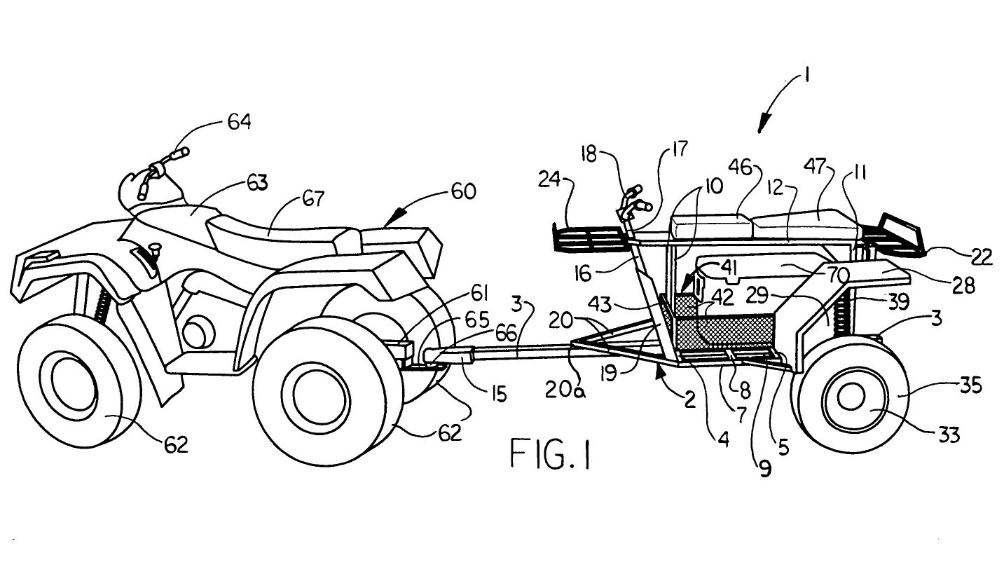

A basket 41 may be provided on the trailer frame 2, beneath the seat frame 12 to carry various supplies or items, such as an ice chest 70, for example. The basket 41 may include a pair of side panels 42, each of which extends between the front vertical frame member 10 and the wheel fender 28 on a corresponding side of the trailer frame 2; a front panel 43 which extends between the side panels 42, as illustrated in FIG. 1; and a rear panel 44 which extends between the rear vertical frame members 11 of the trailer frame 2, as illustrated in FIG. 2. The basket 41 may further include a bottom panel 45 (FIG. 3) which is provided on the trailer frame 2 and extends between the side panels 42 and between the front panel 43 and the rear panel 44. The rear panel 44 may be detachably mounted on the trailer frame 2 to facilitate the placement of items and supplies, such as the ice chest 70, for example, in the basket 41.

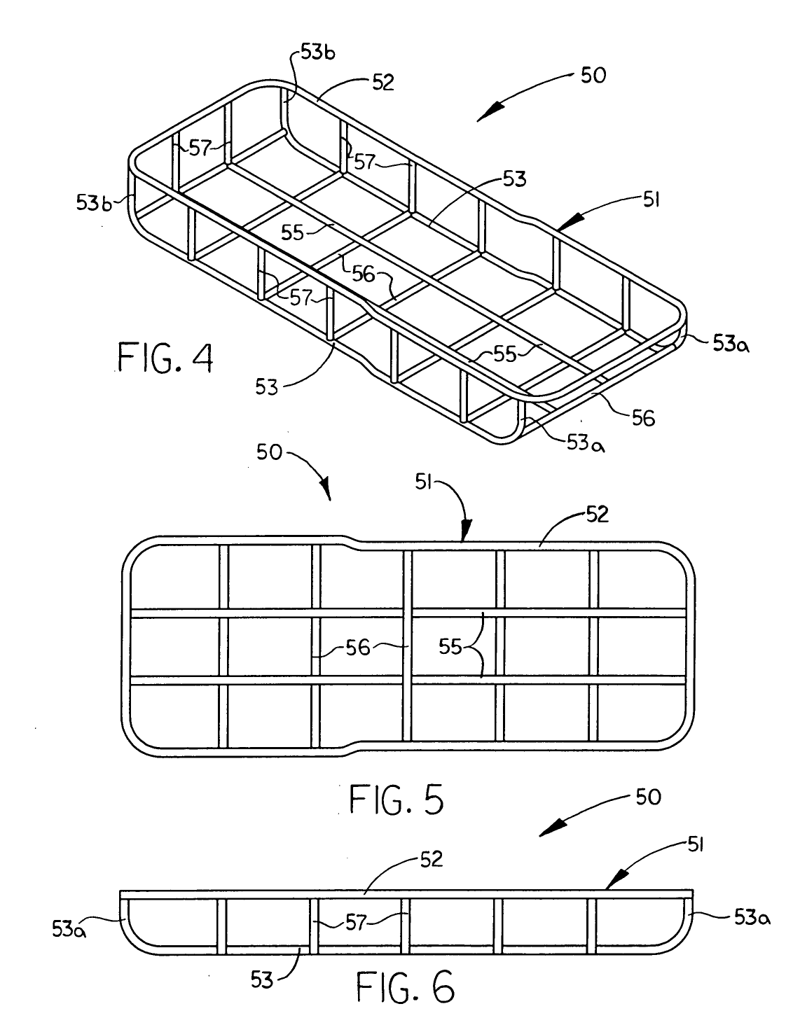

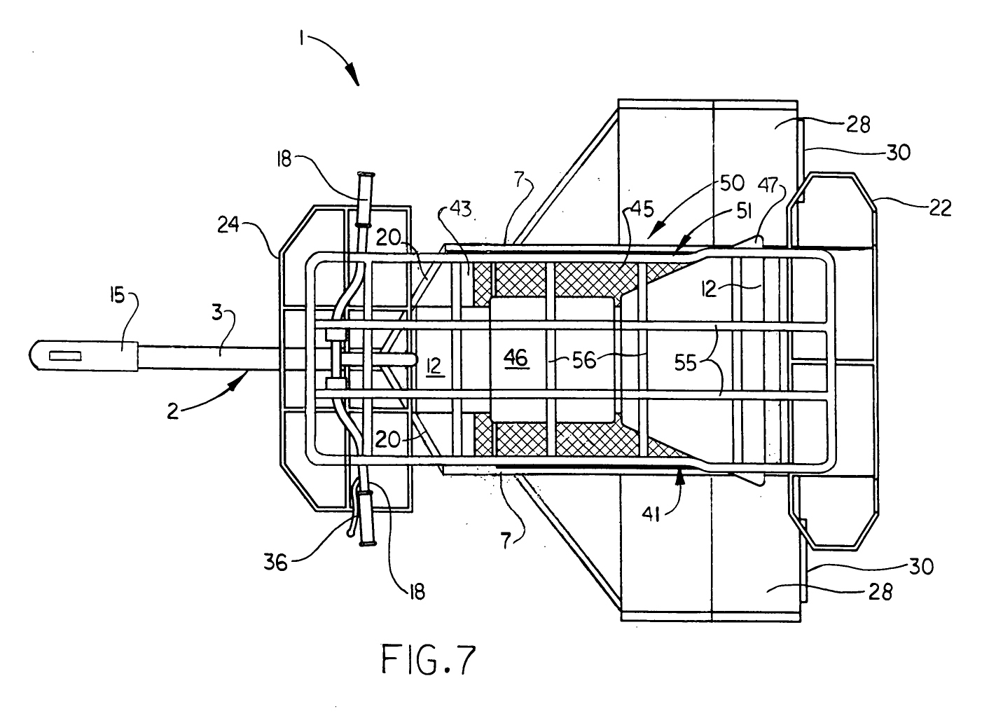

As shown in FIGS. 3 and 7, the ATV trailer 1 may further include a stretcher 50 which can be supported on and attached to the ATV trailer 1 to transport an injured person (not illustrated), as needed. An example of a stretcher 50 which is suitable for the purpose is illustrated in FIGS. 4-6. However, it will be recognized and understood that the stretcher 50 may have a design which departs from that which will be hereinafter described. The stretcher 50 typically includes a stretcher frame 51 having an elongated, generally rectangular top frame member 52. A side frame member 53 is attached to each side of the top frame member 52, typically through a front segment 53a and a rear segment 53b of the side frame member 53. Multiple vertical frame members 57 may span the top frame member 52 and each side frame member 53. Multiple transverse frame braces 56 span the side frame members 53, in spaced-apart relationship to each other. Multiple longitudinal frame braces 55 intersect the transverse frame members 56, in generally parallel, spaced-apart relationship to each other. Vertical frame members 57 may extend between the top frame member 52 and the rearmost of the transverse frame braces 56.

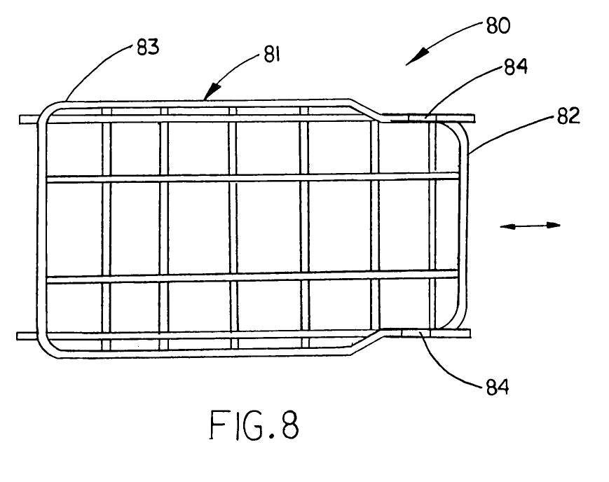

Referring next to FIG. 8, a collapsible stretcher 80 which is suitable for use with the ATV trailer 1 is illustrated. The collapsible stretcher 80 may include, for example, a stretcher frame 81 having a front frame section 82 and a rear frame section 83. A pair of sleeves 84 is provided typically on the rear frame section 83 to facilitate slidable mounting of the front frame section 82 on the rear frame section 83. Accordingly, the collapsible stretcher 80 may be disposed in the collapsed configuration shown in FIG. 8 to facilitate space-efficient storage when not in use. The front frame section 82 can be slidably extended from the rear frame section 83 to impart an extended, functional configuration to the collapsible stretcher 80 for attachment of the collapsible stretcher 80 to the ATV trailer 1, as needed to transport an injured person, for example. The extended configuration of the collapsible stretcher 80 is similar to the configuration shown with respect to the stretcher 50 of FIGS. 4-6.

In typical use of the ATV trailer 1, the trailer frame 2 is coupled to the ATV 60 typically by hitching the ball coupling 15 on the trailer tongue 3 to the hitch ball 66 on the hitch bar 65 of the ATV 60. Various items or supplies, such as hunting or camping equipment (not shown) or an ice chest 70, for example, may be placed in the basket 41 on the trailer frame 2. This is carried out typically by removing the rear panel 44 from the basket 41, sliding the ice chest 70 or other items or supplies into the basket 41, and replacing the rear panel 4 on the basket 41. Additional items or supplies (not shown) may be fastened on the rear rack 22, the front rack 24, or both the rear rack 22 and the front rack 24. One or multiple persons (not illustrated) may sit on the front seat 46 or on both the front seat 46 and the rear seat 47 of the ATV trailer 1 as the ATV trailer 1 is towed by the ATV 60. The person who sits on the front seat 46 may grip the handlebars 18. As the ATV 60 tows the ATV trailer 1, the shock absorbers 39 absorb shock in the event that the ATV trailer 1 traverses rough terrain, imparting a smooth ride to the person or persons sitting on the ATV trailer 1. The dirt shield 19 prevents mud, dirt, rocks and the like from inadvertently striking the items or supplies in the basket 41.

It will be appreciated by those skilled in the art that in the event it becomes necessary to retrieve a person who is injured from a remote campsite, hunting area or the like, the stretcher 50 can be supported by and attached to the ATV trailer 1, as illustrated in phantom in FIG. 3 and in top view in FIG. 7. Accordingly, the handlebars 18 are placed in the lowest possible position on the trailer frame 2 by lowering the handlebar support arm 17 in the handlebar support member 16. The injured person is placed in the stretcher 50, which is then supported on the rear seat 47 and the handlebars 18 and attached to the trailer frame 2 using any suitable technique such as bungee cords, clips, hooks, nylon straps or the like. Emergency medical supplies (not illustrated) can be placed in the basket 41. The injured person can then be towed to a suitable medical facility or the like destination by towing the ATV trailer 1 behind the ATV 60. Upon arrival at the destination, the stretcher 50 is detached from the trailer frame 2 and removed from the ATV trailer 1 for treatment of the injured person.

While the preferred embodiments of the invention have been described above, it will be recognized and understood that various modifications can be made in the invention and the appended claims are intended to cover all such modifications which may fall within the spirit and scope of the invention.

What is claimed is:

1. An ATV trailer, comprising:
a portable trailer frame;
at least one seat carried by said trailer frame; and
a basket carried by said trailer frame beneath said at least one seat.

2. The ATV trailer of claim 1 wherein said at least one seat comprises a front seat and a rear seat.

3. The ATV trailer of claim 1 further comprising at least one rack carried by said trailer frame.

4. The ATV trailer of claim 3 wherein said at least one rack comprises a front rack and a rear rack.

5. The ATV trailer of claim 1 further comprising handlebars carried by said trailer frame.

6. The ATV trailer of claim 5 further comprising a handlebar support member carried by said trailer frame and a handlebar support arm extendable from said handlebar support member, and wherein said handlebars are carried by said handlebar support arm.

7. The ATV trailer of claim 1 wherein said basket comprises a bottom panel, a front panel, a rear panel and side panels carried by said trailer frame.

8. The ATV trailer of claim 1 further comprising a dirt shield carried by said trailer frame adjacent to said basket.

9. An ATV trailer, comprising:
a trailer frame;
a pair of wheels carried by said trailer frame;
at least one seat carried by said trailer frame; and
a basket carried by said trailer frame beneath said at least one seat.

10. The ATV trailer of claim 9 wherein said trailer frame comprises a trailer tongue; a front frame member, a middle frame member and a rear frame member carried by said trailer tongue; a pair of front vertical frame members carried by said front frame member; a pair of rear vertical frame members carried by said rear frame member; and a seat frame carried by said pair of front vertical frame members and said pair of rear vertical frame members, and wherein said at least one seat is carried by said seat frame.

11. The ATV trailer of claim 9 further comprising a pair of brake assemblies engaging said pair of wheels, respectively.

12. The ATV trailer of claim 11 further comprising handlebars carried by said trailer frame.

13. The ATV trailer of claim 12 further comprising a brake handle carried by said handlebars and connected to said pair of brake assemblies.

14. The ATV trailer of claim 13 further comprising at least one light carried by said trailer frame.

15. The ATV trailer of claim 9 further comprising a pair of axles carried by said trailer frame and wherein said pair of wheels is carried by said pair of axles, respectively.

16. The ATV trailer of claim 15 further comprising a pair of shock absorber frame members carried by said trailer frame and a pair of shock absorbers extending between said pair of axles and said pair of shock absorber frame members, respectively.

17. An ATV trailer, comprising:
a portable trailer frame;
at least one seat carried by said trailer frame;
a basket carried by said trailer frame beneath said at least one seat; and
a stretcher detachably carried by said trailer frame.

18. The ATV trailer of claim 17 wherein said stretcher comprises a top frame member, a pair of side frame members carried by said top frame member, a plurality of transverse frame members spanning said pair of side frame members, and a plurality of longitudinal frame members intersecting said plurality of transverse frame members.

19. The ATV trailer of claim 17 wherein said stretcher comprises a collapsible stretcher.

20. The ATV trailer of claim 19 wherein said collapsible stretcher comprises a stretcher frame having a rear frame section and a front frame section slidably carried by said rear frame section.
